(19) United States
(12) Patent Application Publication
(10) Pub. No.: US 2005/0020777 A1
(43) Pub. Date: Jan. 27, 2005

(54) Ethylene-vinyl acetate compositions having improved heat seal properties

(76) Inventors: David Ryan Breese, Loveland, OH (US); Richard T. Sylvester, Middletown, OH (US); Richard F. Knor, Centerville, OH (US)

Correspondence Address: EQUISTAR CHEMICALS, L.P., 11530 NORTHLAKE, CINCINNATI, OH, 45249, US

(21) Appl. No.: 10/625,718

(22) Filed: Jul. 23, 2003

(51) Int. Cl. C08L 33/06

(52) U.S. Cl. 525/228

(57) ABSTRACT

Mixtures of ethylene-vinyl acetate copolymers having different vinyl acetate contents are provided. The compositions which contain a high vinyl acetate copolymer and a low vinyl acetate copolymer in specified amounts are useful for extrusion coating and provide improved heat seal characteristics relative to the individual ethylene-vinyl acetate copolymer components.

### BACKGROUND OF THE INVENTION

1. Field of the Invention

The present invention relates to compositions containing two ethylene-vinyl acetate resins of different vinyl acetate contents. The mixtures when melt blended are useful for extrusion coating and exhibit a combination of high seal strengths and low heat seal initiation temperatures.

2. Description of the Prior Art

Ethylene-vinyl acetate (EVA) copolymers are widely used to extrusion coat a variety of substrates as a result of their desirable processing characteristics and physical properties. In extrusion coating, the EVA resin is melted and formed into a thin hot film which is coated onto a moving substrate, such as paper, plastic film, metal foil or the like. The coated substrate is then passed between rolls which press the coating against the substrate to insure uniform contact of the EVA and substrate and good adhesion after cooling. In other extrusion coating processes, EVA resin is extrusion coated on both sides of a substrate thus forming a sandwich structure.

EVA resins and formulations containing EVA resins are also used for extrusion laminating to provide adhesion between two or more substrates. In these processes the extrusion coating is used as an adhesive layer between the substrates. The extrusion coating is typically applied to a first substrate as described above and then a second substrate is applied to the extrusion coating while it is still molten. The resulting “sandwich” is then passed between pressure rolls.

Extrusion coatings can be utilized to improve the appearance of the substrate material; provide improved tear, scuff or puncture resistance; provide grease, oil or chemical resistance; provide a moisture barrier; or provide a heat sealable surface. This latter feature is particularly significant with EVA resins in view of their good heat sealing properties, hot tack strength and adhesion. EVA resins, depending on their vinyl acetate (VA) contents, are widely used as a heat sealing layer or component of a heat-sealing layer for extrusion coated substrates used for packaging.

In these applications, fast sealing capability at low temperatures with the formation of strong seals is essential. While EVAs with higher VA contents typically have lower sealing temperatures, EVA resins with lower VA contents typically provide higher seal strengths. It would be highly advantageous if compositions having seal strengths typically associated with low VA content EVAs and lower seal initiation temperatures typically achieved with higher VA content EVAs were available. These and other improvements are unexpectedly obtained with the EVA blends of the present invention.

Mixtures of EVA resins are known. For example, U.S. Pat. No. 3,817,821 discloses a blend of EVA resins for useful for the production of laminar film structures having at least three layers. One of the film layers is a blend of 20 to 40 weight percent (wt. %) polybutene-1 or EVA copolymer having a VA content of 35 to 70 wt. % with 60 to 80 wt. % EVA copolymer having a VA content of 5 to 28 wt. %

U.S. Pat. No. 4,247,584 discloses the use of EVA resin blends for the production of heat shrinkable film laminates. EVA copolymers utilized for these blends are low melt index (MI) resins and the VA content of the resulting blends are relatively low. The blends are comprised of about 10 to 90 weight percent of a low VA content EVA copolymer containing about 2 to 12 percent VA and having a melt index of about 0.2 to 10 and about 90 to 10 weight percent of a high VA content EVA copolymer containing about 8 to 30 percent of VA and having a melt index of about 0.2 to 5. In the blend, the percent of VA in the low EVA copolymer is below that in the high EVA copolymer and the weight average VA content is about 4 to 15 percent.

### SUMMARY OF THE INVENTION

Ethylene-vinyl acetate compositions useful for extrusion coating are provided. The compositions are a mixture of 20 to 80 weight percent first ethylene-vinyl acetate copolymer having a vinyl acetate content from 9 to 20 wt. % and 80 to 20 weight percent second ethylene-vinyl acetate copolymer having a vinyl acetate content from 22 to 34 wt. %. Vinyl acetate contents of the mixtures will be from 10 to 30 wt. %. The mixtures are melt blended for extrusion coating. MIs of the blends are from 5 to 40 g/10 min. Compositions comprised of 30 to 70 wt. % of the first EVA copolymer resin and 70 to 30 wt. % of the second EVA copolymer are particularly useful for extrusion coating and provide higher seal strengths at lower heat seal temperatures. Preferred first and second EVA copolymers have VA contents from 12 to 20 wt. % and 24 to 32 wt. %, respectively.

### DETAILED DESCRIPTION

The present invention relates to improved extrusion coating compositions and, more specifically, to mixtures of EVA resins and blends thereof exhibiting high seal strengths at lower heat seal temperatures. For heat seal applications, the ability to achieve good seal strengths is paramount; however, there is increasing emphasis on the part of the packaging industry to increase production rates and line speeds of packaging operations. Since the heat sealing step is typically the rate limiting step in such operations there is increased emphasis on developing sealing compositions which can achieve the desired seal strength at lower heat seal initiation temperatures. This enables packages to reduce the length of time the seal bars are in contact with the packaging material so that more units can be sealed in a given period of time. Additionally, it may be possible to reduce the temperature of the seal bars which will further improve the economics of the process.

Heretofore, in order to lower heat seal initiation temperatures and increase production, conventional practice has been to increase the VA content of the EVA heat seal resin which in turn reduces the seal strength which can result in an undesirable high seal failure rates if the critical balance of these two parameters is not properly maintained. Moreover, for reactor produced EVA resins there is an optimum seal strength at any given VA content.

With the compositions of the present invention we have unexpectedly found it is possible to achieve higher seal strengths at lower heat seal temperatures. In some mixtures it is also possible to obtain a higher ultimate seal strength with the blends than can be achieved with either of the individual EVA resin components at specific heat sealing temperatures.

To achieve the improved extrusion coating compositions of the invention a first and second EVA copolymer are combined. The first EVA copolymer, also referred to as the low VA content copolymer, has a VA content of 9 to 20 wt. % and, more preferably, 12 to 20 wt. %. The low VA content copolymer constitutes 20 to 80 wt. % and, more preferably, 30 to 70 wt. % of the composition. The second EVA copolymer, also referred to herein as the high VA content copolymer, has a VA content of 22 to 34 wt. % and, more preferably, 24 to 32 wt. %. The high VA content copolymer comprises 80 to 20 wt. % and, more preferably, 70 to 30 wt. % of the composition. All weight percentages referred to herein are based on the total weight of the composition.

The high and low VA content components are melt blended to obtain the extrusion coating composition. This is generally accomplished by dry-blending the high and low VA content EVA resins in the desired ratio and then melt blending the mixture using conventional means, such as an extruder or Banbury mixer. Melt blending is usually carried out at temperatures from about 300° F. up to about 400° F. The resulting melt blended composition may be directly coextruded or the blend may be pelletized and stored for subsequent use.

Blended compositions useful for the invention will have VA contents from 10 to 30 wt. % and melt indexes (MIs) from 5 to 40 g/10 min. MIs are determined in accordance with ASTM Test Method D 1238-01, condition 190/2.16. Preferably, the VA content of the blends is from 15 to 28 wt. %. Blend MIs are preferably 7 to 35 g/10 min.

The compositions of the invention are suitable for the manufacture of extrusion coatings and laminates using conventional monolayer or coextrusion procedures known to the art. A comprehensive description of extrusion coating techniques and applications is provided in the technical manual published by Equistar Chemicals, LP entitled “A Guide to Polyolefin Extrusion Coating,” copyright 1997; 6664/V308/Reprint 12/97.

The following examples illustrate the improvement obtained with the EVA blend compositions of the invention. Those skilled in the art, however, will recognize numerous possible variations which are within the spirit of the invention and scope of the claims.

For these examples, blends were prepared from mixtures of various EVA copolymer resins obtained from commercial sources. The EVA resins are identified below and the MI and VA content (wt. %) provided for each.
EVA 1:MI 26 g/10 min; 28% VA
EVA 2:MI 26 g/10 min; 18% VA
EVA 3:MI 26 g/10 min; 15% VA
EVA 4:MI 26 g/10 min; 15% VA
   The blends were prepared by dry-blending specified amounts of two or more of the above-identified EVA resins. The resulting EVA resin mixtures were then extrusion coated onto 2 mil poly(ethylene terephthalate) film (PET) for evaluation of heat sealability characteristics. Extrusion coating was carried out on a commercial coating line operating at a rate of 300 feet per minute. The film width was 30 inches. Prior to coating, the PET film was surface treated by coating with a water-based primer (MICA A131), corona treatment and ozone treatment, or some combination thereof. All of these surface treatments are conventional techniques typically used in commercial operations to insure good adhesion of extrusion coatings to PET films. All of the surface treatment procedures were performed in-line with the extrusion coater.

Extrusion coating was accomplished using a Beloit single screw extruder (L/D 24:1; screw speed 19 rpm) having five heating zones. The temperature profile for the five zones was as follows:
Zone 1: 275° F.
Zone 2: 325° F.
Zone 3: 400° F.
Zones 4 and 5: 450° F.
   The die temperature was 450° F. Extrusion coating thickness was 0.5 mil. After application of the extrusion coating the coated film was passed through a chill roll maintained at approximately 60° F.

Films coated with the EVA were evaluated to determine seal strength over the temperature range 125° F. to 180° F. in accordance with ASTM Test Method F88-94. This procedure measures the seal strength of flexible barrier materials and, more specifically, the force required to tear apart a seal of standard width. For the test, fin seal test specimens were cut from the above-prepared extrusion coated PET films and sealed using a Sencorp Model 12 ASL/1 heat sealer for 0.5 seconds and 40 psi. Both jaws were heated. After conditioning, the test specimens were pulled in a tensile testing machine at a rate of 20 inches/minute. The maximum force required to cause seal failure at a given seal temperature is reported as the seal strength. Seal strengths are expressed in pounds—force per inch of width and are the average of 5 replicates.

The commercial EVA resins used to prepare the blends were also evaluated to determine their heat seal characteristics. These data are presented for comparison to demonstrate the improved results obtained with the inventive blends prepared therefrom.

In the tables which follow “NS” indicates that no seal was obtained at the specified temperature. The notation “SO” signifies “squeeze out.” Squeeze out is an art recognized phenomenon for an unsatisfactory condition which occurs when heat sealing EVA resins at temperatures above optimum. As the seal temperature is increased for a given EVA resin, it will eventually reach a point where, due to the temperature-viscosity relationship of the particular resin, the resin becomes so fluid that the pressure of the seal bars causes the EVA extrusion coating to be squeezed out of the area to be sealed leaving an inadequate amount of material to form a seal.

A blend was prepared in accordance with the above-described procedure by combining EVA 1 and EVA 2. The resulting blend, identified as Blend A, comprised of 70 wt. % of the higher VA content EVA resin and 30 wt. % of the EVA resin having a lower VA content, had a VA content of 25 wt. % and MI of 26 g/10 min. This blend was extrusion coated onto PET film and evaluated for heat seal as described above. The PET film used for this evaluation was coated with sufficient water-based primer (MICA A131) to wet the surface, corona treated and ozonated prior to application of the extrusion coating. Heat seal results over the 125-180° F. range obtained for the blend and the individual EVA components are tabulated in Table 1. It is apparent from the data that the blend had significantly higher seal strength than could be achieved using the high VA content by itself. For example, whereas a maximum seal strength of only 3.3 pounds could be achieved using EVA 1 before squeeze out occurred, a seal strength of 6.9 lbs was achieved with the blend. Moreover, the temperature at which squeeze out occurred was 5° F. higher. While it was possible to obtain high seal strengths with the lower VA content resin component, i.e., EVA 2, comparable seal strengths were achieved with the blend at significantly lower temperatures. This is advantageous for processors since the heat sealing step often limits overall output rates in many operations such as thermal lamination and pouch forming. For example, if a processor is manufacturing a pouch and requires a seal strength of 1-2 pounds he can achieve this magnitude of seal more rapidly with the EVA blends of the invention because this seal strength is achieved at a temperature of about 135° F. using the inventive blends whereas a temperature of about 160° F. would be required to achieve the same seal strength using the commercial EVA 2 resin. The advantages of combining two commercially available EVA resins to obtain a composition with VA content which is not commercially produced and which exhibits desired heat seal characteristics are thus apparent.

Similar improvements were achieved when EVA 1 and EVA 2 were combined at slightly different ratios to produce a blend, referred to as Blend B, with VA content of 21 wt. %. This composition contained 30 wt. % EVA 1 and 70 wt. % EVA 2. Heat seal results were generated in the same manner and are set forth in Table 1.

TABLE 1

Seal Strength

| Seal Temperature | Blend A | Blend B | EVA 1 | EVA 2 |
|---|---|---|---|---|
| 125 | 0.3 | NS | 0.4 | NS |
| 130 | 1.1 | NS | 0.8 | NS |
| 135 | 1.8 | 0.4 | 1.8 | NS |
| 140 | 2.2 | 1.0 | 2.5 | NS |
| 145 | 3.2 | 1.7 | 3.1 | NS |
| 150 | 3.7 | 2.1 | 3.0 | NS |
| 155 | 4.8 | 2.2 | 2.8 | 0.6 |
| 160 | 5.6 | 4.4 | 3.3 | 1.8 |
| 165 | 6.9 | 5.4 | SO | 2.8 |
| 170 | SO | 6.7 | SO | 4.1 |
| 175 | SO | SO | SO | 4.6 |
| 180 | SO | SO | SO | 5.0 |

These data demonstrate the ability to design products having desired heat seal characteritics by varying the weight ratio of two commercial EVA resins. Moreover, the blend of the two components exhibits a synergistic sealing nature, relative to each of its components. When considering a blend of the two components, a lower heat seal initation temperature needed to produce an acceptable seal as well higher seal strengths in the lower half of the seal curve are achieved relative to that of the low VA component. Higher ultimate seal strengths are achieved for seals made with the blend relative to the high VA component. By varying the amount of each component in the blend, one can slightly modify these observed properties, but the presence of both enhancements is still evident as a result of blending the two components.

With specific reference to the data set forth in Table 1, one would expect the blend to have properties only as good as the best component at a given temperature. Indeed, at the lower seal initiation temperatures of 125 to about 150° F. this is generally the case. Seal strengths of the blends closely parallel the performance of the high VA content component. However, as the seal initiation temperature is increased up to about 170° F., a marked increase in seal strength, greater than attributable to the low VA content EVA resin, is surprisingly observed. While one would expect the performance of the blend to be extended beyond that of the high VA content resin at these higher temperatures due to the presence of the low VA content component, it would not be expected that the performance of the blend at the high seal initiation temperatures would exceed that of the low VA content EVA component. However, that is surprisingly the case. For example, when one observes the seal strengths achieved at a seal initiation temperature of 160° F., the respective seal strengths of the high and low EVA components are 3.3 and 1.8 pounds-force per inch of width whereas the average seal strength of the two blends is 5 pounds-force per inch of width.

A further unexpected advantage of the compositions is apparent from the data, namely, that it is possible to achieve a target seal strength at a lower seal initiation temperature. If, for example, a processor were fabricating a heat sealed package with a requirement that the force to separate the heat seal be approximately 4.5 pounds-force per inch of width, this seal could be achieved using the blend compositions at a temperature in the range 155-160° F. Such a seal strength is not even possible utilizing the high VA content EVA resin by itself and, if the low VA content EVA resin were used by itself, the seal initiation temperature would need to be approximately 175° C. The ability to achieve the desired seal strength at the lower temperature provides an economic advantage to the processor due to the reduced energy requirements as well as other processing advantages.

Even if commercial EVA resins having VA contents of 25 and 21 wt. % (the VA contents of Blend A and Blend B, respectively) were available, it is anticipated, based on extrapolation of the data generated for EVA 1 and EVA 2, that significantly higher seal initiation temperatures would be required in order to obtain seal strengths comparable to that achieved with the corresponding VA content blend.

To demonstrate the ability to obtain useful blends using other commercial EVA resins, a blend (referred to as Blend C) was obtained by combining 77 wt. % EVA 1 and 23 wt. % EVA 3. The resulting blend had a VA content of 25 wt. % and MI of 26 g/10 min. This blend was extrusion coated onto PET film which was corona treated and ozonated. Heat seal characteristics obtained with this blend are provided in Table 2 along with results obtained for the individual components, EVA 1 and EVA 3, extrusion coated using the same PET film and conditions.

Another 25 wt. % of VA content blend (identified as Blend D) was prepared and evaluated. For this blend, 77 wt. % EVA 1 and 23 wt. % EVA 4 were combined per the standard procedure and extrusion coated onto PET film surface-treated by corona treatment and ozonation. Heat seal results obtained for the blend are set forth in Table 2. Results obtained for the Blends C and D clearly show the repeatability of the sealing properties of the blends. The data also demonstrate that by blending high and low VA components one can achieve a lower heat seal initiation temperature and higher ultimate seal strengths at lower sealing temperatures relative to the individual blend components.

TABLE 2

Seal Strength

| Seal Temperature | Blend C | Blend D | EVA 3 | EVA 4 |
|---|---|---|---|---|
| 125 | NS | 0.3 | NS | NS |
| 130 | 0.6 | 0.6 | NS | NS |
| 135 | 1.3 | 1.2 | NS | NS |
| 140 | 2.0 | 1.8 | NS | NS |
| 145 | 3.1 | 2.5 | NS | NS |
| 150 | 3.4 | 3.1 | NS | NS |
| 155 | SO | SO | NS | 0.2 |
| 160 | SO | SO | 0.6 | 0.5 |
| 165 | SO | SO | 1.2 | 1.2 |
| 170 | SO | SO | 1.5 | 1.6 |
| 175 | SO | SO | 1.6 | 1.8 |
| 180 | SO | SO | 1.7 | 1.8 |

1. An ethylene-vinyl acetate composition comprising a mixture of 20 to 80 weight percent first ethylene-vinyl acetate copolymer having a vinyl acetate content from 9 to 20 weight percent and 80 to 20 weight percent second ethylene-vinyl acetate copolymer having a vinyl acetate content from 22 to 34 weight percent, said mixture having a vinyl acetate content from 10 to 30 weight percent.

2. The composition of claim 1 wherein the first ethylene-vinyl acetate copolymer has a vinyl acetate content from 12 to 20 weight percent.

3. The composition of claim 2 wherein the first ethylene-vinyl acetate copolymer comprises 30 to 70 weight percent of the mixture.

4. The composition of claim 1 wherein the second ethylene-vinyl acetate copolymer has a vinyl acetate content from 24 to 32 weight percent.

5. The composition of claim 4 wherein the second ethylene-vinyl acetate copolymer comprises 70 to 30 weight percent of the mixture.

6. The composition of claim 1 wherein the vinyl acetate content of the mixture is 15 to 28 weight percent.

7. The composition of claim 1 which is melt blended and the melt index of the blend is 5 to 40 g/10 min.

8. The composition of claim 7 wherein the melt index of the blend is 7 to 35 g/10 min.

9. The composition of claim 7 wherein the first ethylene-vinyl acetate copolymer has a vinyl acetate content from 12 to 20 weight percent.

10. The composition of claim 9 wherein the first ethylene-vinyl acetate copolymer comprises 30 to 70 weight percent of the mixture.

11. The composition of claim 7 wherein the second ethylene-vinyl acetate copolymer has a vinyl acetate content from 24 to 32 weight percent.

12. The composition of claim 11 wherein the second ethylene-vinyl acetate copolymer comprises 70 to 30 percent of the mixture.
